(19) United States
(12) Patent Application Publication
(10) Pub. No.: US 2025/0320372 A1
(43) Pub. Date: Oct. 16, 2025

(54) COLLOIDAL DISPERSIONS AND PROCESSES OF MAKING AND USING SAME

(71) Applicant: Government of the United States as represented by the Secretary of the Air Force, Wright-Patterson AFB, OH (US)

(72) Inventors: Peter Stevenson, Dayton, OH (US); Michael E. Mcconney, Beavercreek, OH (US); Urice N. Tohgha, Beavercreek, OH (US); Kyle J. Carothers, Dayton, OH (US); Michael A. Susner, Kettering, OH (US)

(21) Appl. No.: 19/047,963

(22) Filed: Feb. 7, 2025

Related U.S. Application Data
(60) Provisional application No. 63/632,090, filed on Apr. 10, 2024.

(51) Int. Cl. C09D 133/12; B33Y 10/00; C08K 3/11; C09D 133/10; C09D 135/04

(52) U.S. Cl. CPC C09D 133/12; C08K 3/11; C09D 133/10; C09D 135/04; B33Y 10/00

(57) ABSTRACT

The present invention relates to colloidal dispersions and processes of making and using same. Such dispersions comprise an organic monomer and van der Waals materials having little or no oxidation and conformational distortion. As a result, such dispersions can provide two dimensional and three dimensional structures that are made from, in whole or in part, from such colloidal dispersions with unique optical, magnetic and electrical properties. Processes of making and using such dispersions are also disclosed.

### CROSS-REFERENCE TO RELATED APPLICATIONS

The present application claims priority to U.S. Provisional Application Ser. No. 63/632,090 filed Apr. 10, 2024, the contents of such provisional application hereby being incorporated by reference in its entry.

### RIGHTS OF THE GOVERNMENT

The invention described herein may be manufactured and used by or for the Government of the United States for all governmental purposes without the payment of any royalty.

### FIELD OF THE INVENTION

The present invention relates to colloidal dispersions and processes of making and using same.

### BACKGROUND OF THE INVENTION

Colloidal dispersions facilitate the application of desirable materials in a number of applications. Colloidal dispersions that comprise van der Waals materials are of particular interest as van der Waals materials have unique optical, magnetic and electrical properties. Such unique properties can be provided to two dimensional and three-dimensional structures when such structures are made from, in whole or in part, such colloidal dispersions. Unfortunately, current processes that are used to produce colloidal dispersions that comprise van der Waals materials, physically or chemically damage the van der Waals materials during the dispersion making process. Such damage results in significant damage to the van der Waals materials unique properties.

Applicants recognized that aggressive oxidation and conformational distortion of the van der Waals materials, that occurs during the dispersion making process, were the primary sources of the aforementioned damage. Thus, Applicants provide herein a flexible dispersion making process that yields little or no oxidation and conformational distortion of the van der Waals materials. Thus, the van der Waals materials, among other advantages, can be readily made into films and substrates. While not being bound by theory, Applicants believe that such benefits are achieved by exfoliating the van der Waals materials, via sonication, directly in an organic monomer.

### SUMMARY OF THE INVENTION

The present invention relates to colloidal dispersions and processes of making and using same. Such dispersions comprise an organic monomer and van der Waals materials having little or no oxidation and conformational distortion. As a result, such dispersions can provide two dimensional and three dimensional structures that are made from, in whole or in part, from such colloidal dispersions with unique optical, magnetic and electrical properties. Processes of making and using such dispersions are also disclosed.

Additional objects, advantages, and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic depicting the exfoliation process using organic monomers.

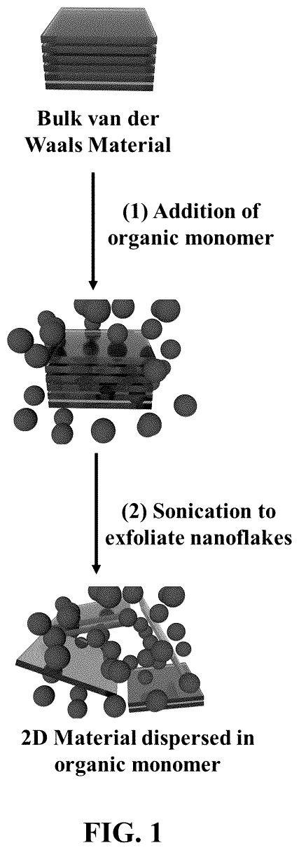

FIG. 2 is a picture of a colloidal dispersion comprising vinyl methacrylate monomer and exfoliated two-dimensional MoS₂.

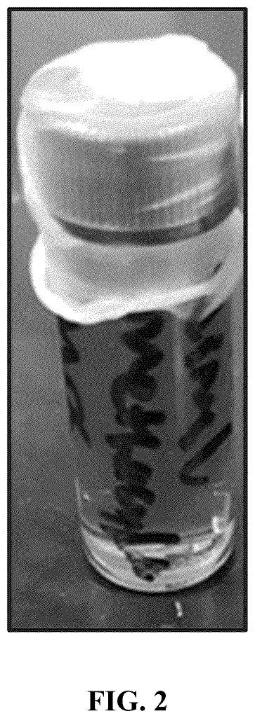

FIG. 3 is a picture of a colloidal dispersion comprising vinyl acetate monomer and exfoliated two-dimensional MoS₂.

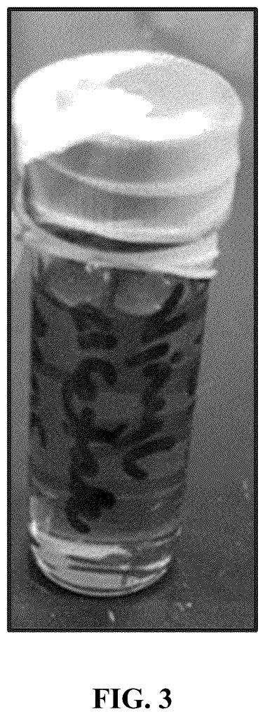

FIG. 4 is a picture of a colloidal dispersion comprising triallyl monomer crosslinker monomer and exfoliated two-dimensional MoS₂.

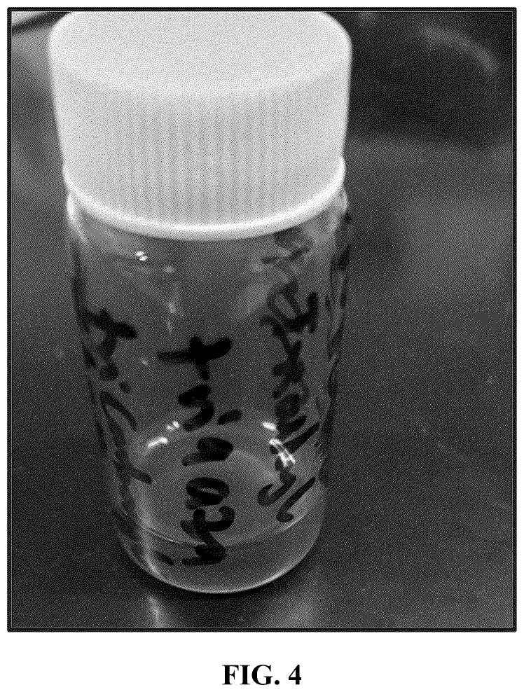

FIG. 5 is a picture of a colloidal dispersion comprising styrene monomer and exfoliated two-dimensional MoS₂.

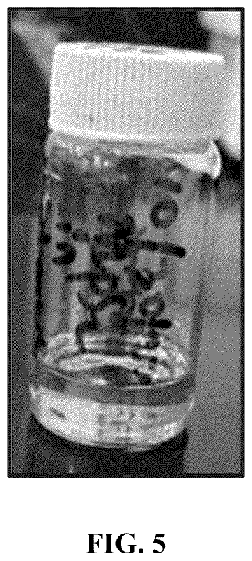

FIG. 6 is a picture of a colloidal dispersion comprising methyl methacrylate monomer and exfoliated two-dimensional MoS₂.

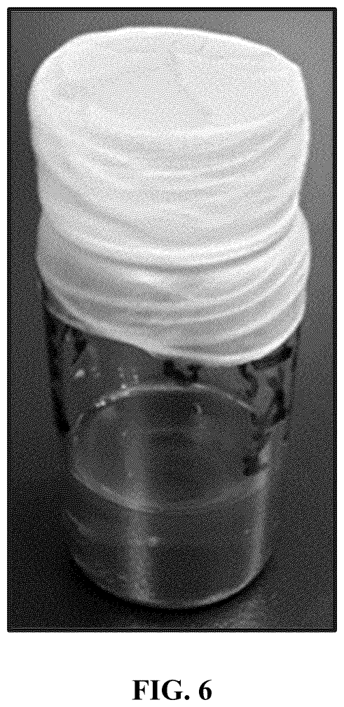

FIG. 7 is a picture of a colloidal dispersion comprising methyl methacrylate monomer and exfoliated two-dimensional Fe₂O₃ (hematene).

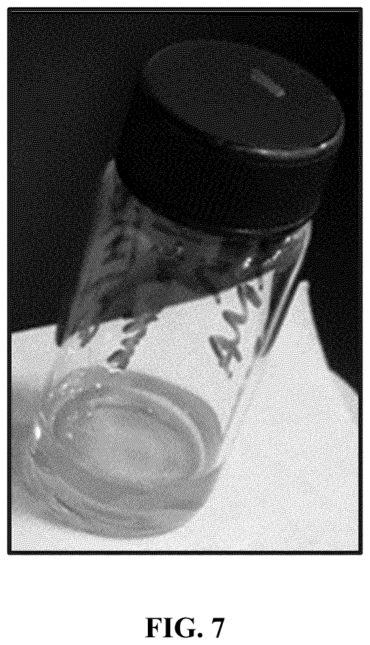

FIG. 8 is a picture of a colloidal dispersion comprising lauryl methacrylate monomer and exfoliated two-dimensional MoS₂.

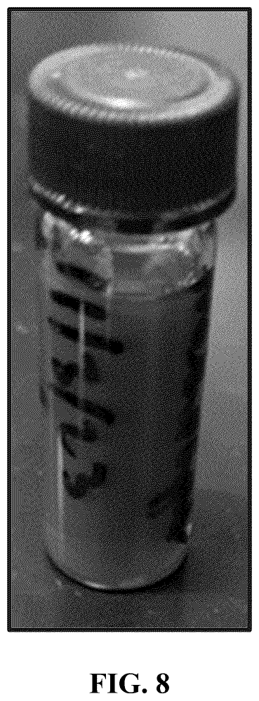

FIG. 9 is a picture of a colloidal dispersion comprising ethyl 2-cyanoacrylate monomer and exfoliated two-dimensional MoS₂.

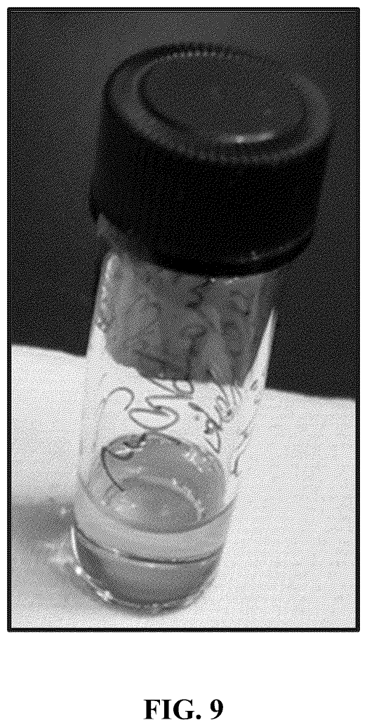

FIG. 10 is a picture of a colloidal dispersion comprising diacrylate monomer (left) and triacrylate monomer (right) and exfoliated two-dimensional MoS₂.

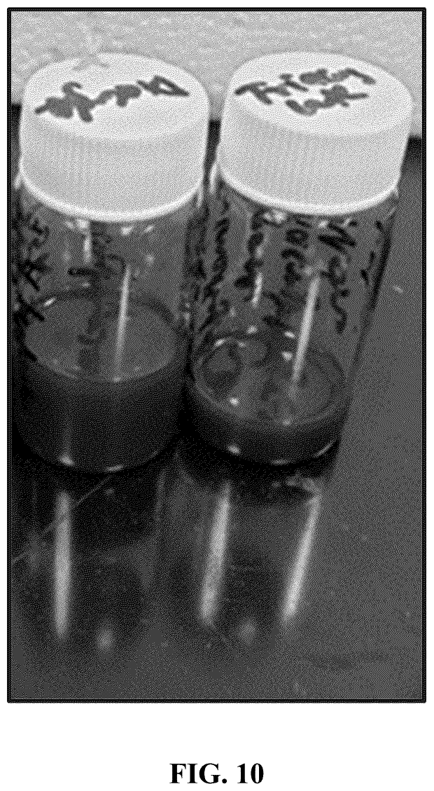

FIG. 11 is a picture of a colloidal dispersion comprising styrene monomer with 5 wt. % acetonitrile organic solvent and exfoliated two-dimensional MoS₂.

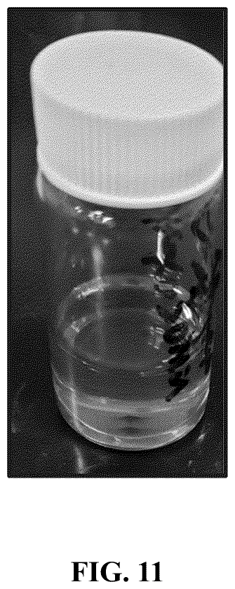

FIG. 12 is a picture of a colloidal dispersion comprising 4-vinyl aniline monomer and exfoliated two-dimensional MoS₂.

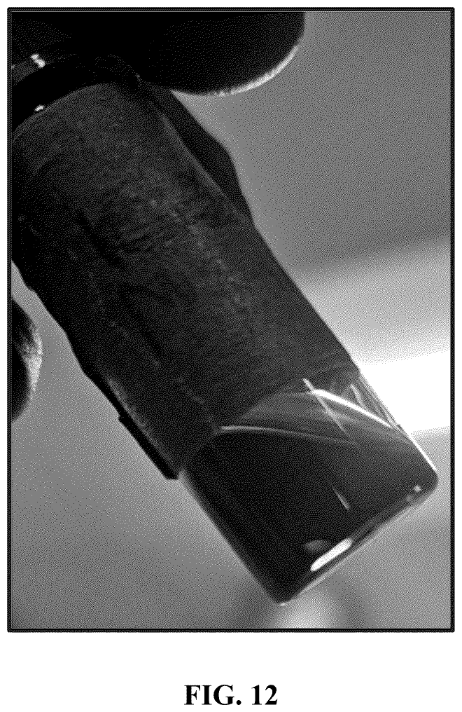

FIG. 13 is a transmission electron microscopy image of exfoliated two-dimensional MoS₂ nanoflakes prepared using methyl methacrylate monomer.

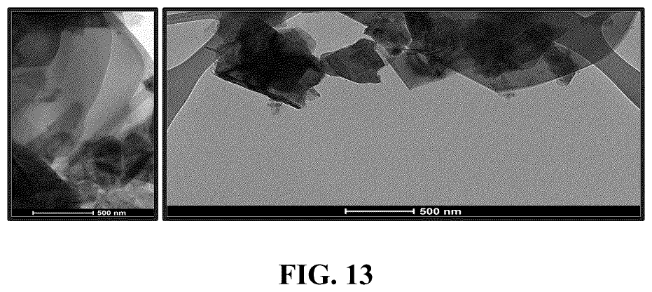

FIG. 14 is a transmission electron microscopy image of exfoliated two-dimensional MoS₂ nanoflakes prepared using trimethylol propane triacrylate monomer.

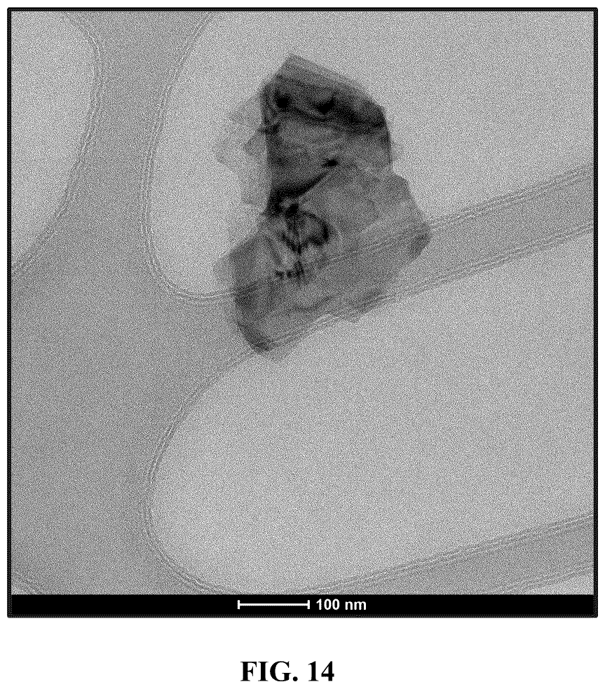

FIG. 15 is a transmission electron microscopy image of exfoliated two-dimensional MoS₂ nanoflakes prepared using 4-vinyl aniline monomer.

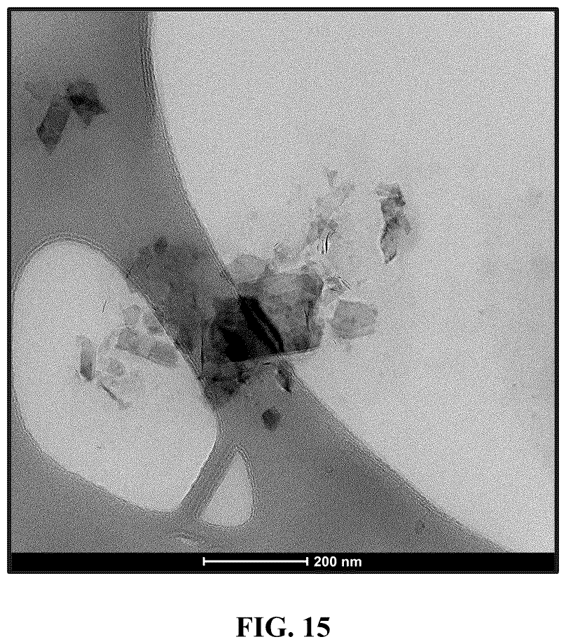

FIG. 16 is a transmission electron microscopy image of exfoliated two-dimensional MoS₂ nanoflakes prepared using styrene monomer.

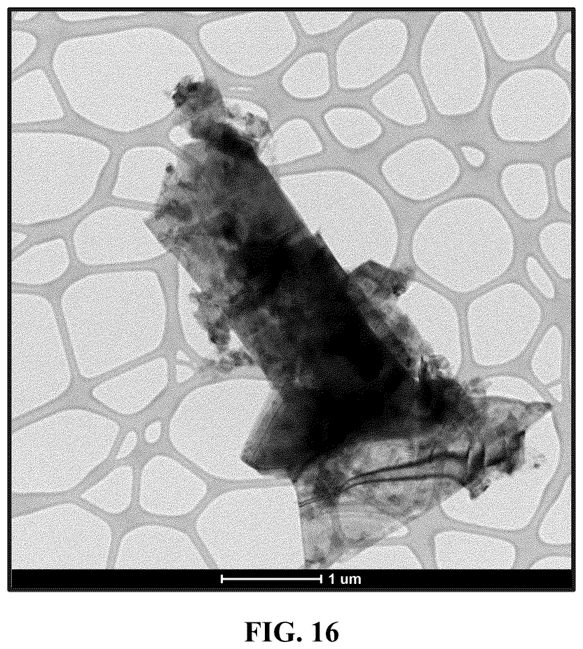

FIG. 17 is a transmission electron microscopy image of exfoliated two-dimensional Fe₂O₃ (hematene) nanoflakes prepared using methyl methacrylate monomer.

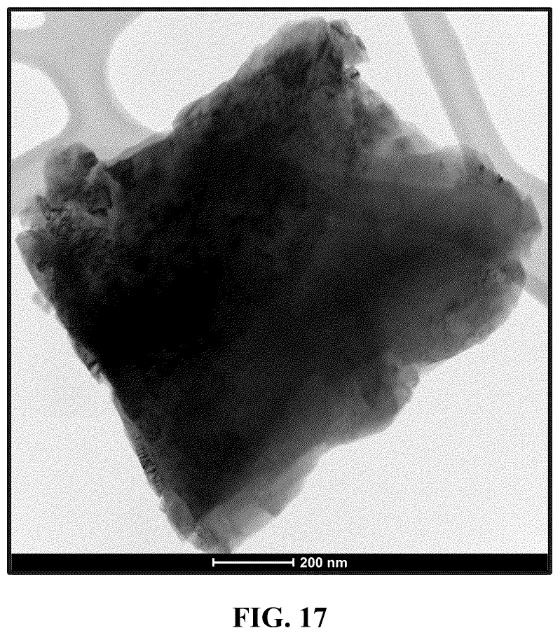

FIG. 18 is a plot showing spectral of methyl methacrylate monomer, colloidal dispersion of methyl methacrylate monomer+exfoliated two-dimensional MoS₂, and colloidal dispersion of methyl methacrylate monomer+exfoliated two-dimensional WS₂.

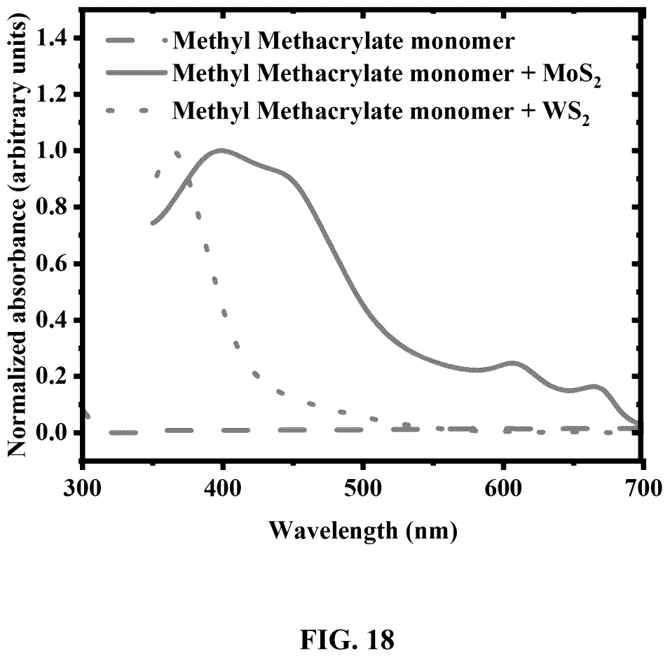

FIG. 19 is a plot showing spectral of lauryl methacrylate monomer, colloidal dispersion of lauryl methacrylate monomer+exfoliated two-dimensional MoS₂, and colloidal dispersion of lauryl methacrylate monomer+exfoliated two-dimensional WS₂.

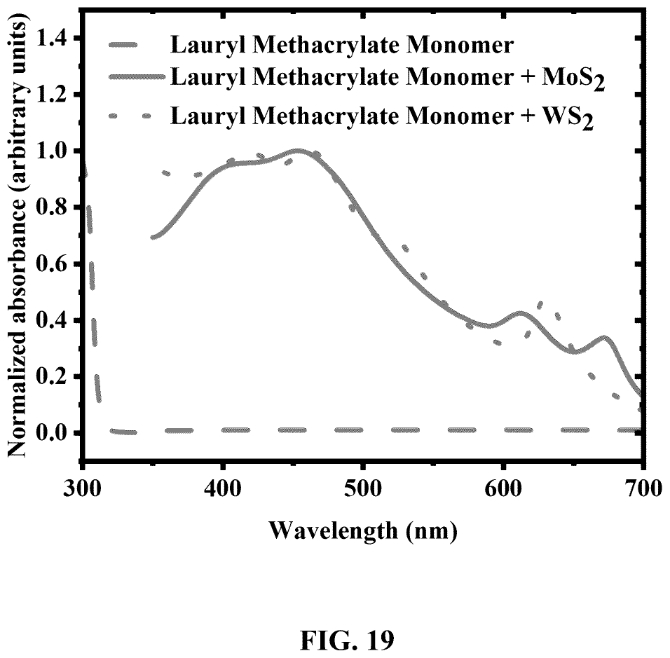

FIG. 20 is a plot showing spectral of n-butyl methacrylate monomer, colloidal dispersion of n-butyl methacrylate monomer+exfoliated two-dimensional MoS₂, and colloidal dispersion of n-butyl methacrylate monomer+exfoliated two-dimensional WS₂.

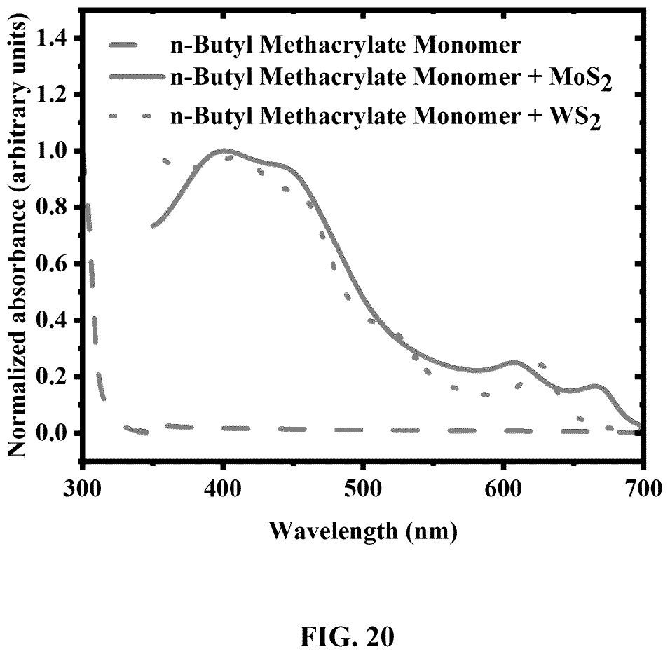

FIG. 21 is a plot showing spectral of stearyl methacrylate monomer, colloidal dispersion of stearyl methacrylate monomer+exfoliated two-dimensional MoS₂, and colloidal dispersion of stearyl methacrylate monomer+exfoliated two-dimensional WS₂.

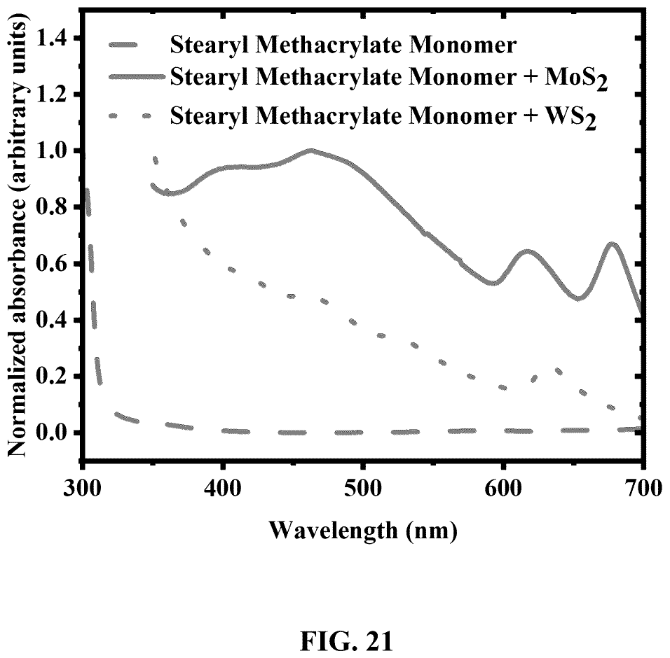

FIG. 22 shows two images of polymer matrix composite films on glass slides of cured methyl methacrylate polymer embedded with exfoliated two-dimensional MoS₂.

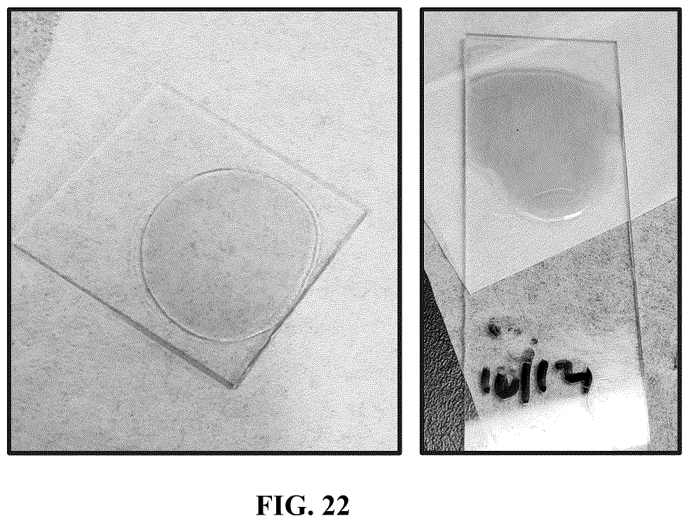

FIG. 23 shows two images of polymer matrix composite materials including (left) bulk cured methyl methacrylate polymer embedded with exfoliated two-dimensional Fe₂O₃ (hematene) and (right) thin film methyl methacrylate polymer embedded with exfoliated two-dimensional Fe₂O₃ (hematene).

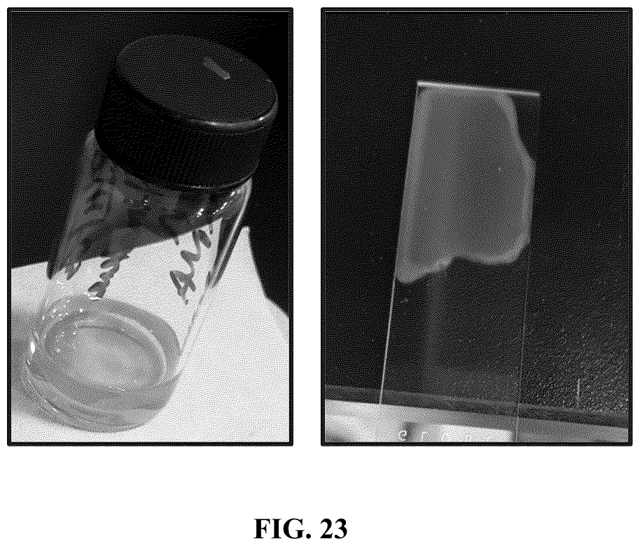

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A, B and/or C) that the embodiment may have element A alone, element B alone, element C alone, or any combination elements A, B and C taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Colloidal Dispersions and Processes of Making and Using Same

In this paragraph Applicants disclose a process for producing a colloidal dispersion, said process comprising: bath sonicating a first mixture comprising a three-dimensional van der Waals material, a liquid having a viscosity of from about 0.1 cP to about 1000 cP, preferably from 0.1 cP to about 100 cP, said liquid comprising a monomer, dimer, trimer and/or oligomer, and an optional stabilizer to form a second mixture comprising said three-dimensional van der Waals material, a two-dimensional material and said liquid; and centrifuging said second mixture to separate said second mixture into a third mixture comprising said three-dimensional van der Waals material, an optional stabilizer, two-dimensional material, and said liquid; and a colloidal dispersion comprising said two-dimensional material, an optional stabilizer, and said liquid. Bath sonication is a mild sonication approach that enables direct exfoliation of two-dimensional materials in monomers with minimal or inadvertent, polymerization of the mixture. In other words, the typical probe sonication, chemical exfoliation, or artificial redox exfoliation methodologies used in the community is accompanied by a substantial increase in temperature or change in the chemical composition of the exfoliation slurry and colloidal dispersion that will result in ‘premature’ polymerization of the mixture.

In this paragraph Applicants disclose a the process of the previous paragraph wherein: said monomer is selected from the group consisting of olefin, vinyl, diene, styrenic, acrylic, condensation, amide, epoxy, and silicone monomers and mixtures thereof; said dimer is selected from the group consisting of disulfide, diol, disiloxane, diamine, diacid, diisocyanate, and diester dimers and mixtures thereof; said trimer is selected from the group consisting of trisulfide, triol, trisiloxane, triamine, triacid, triisocyanate, and triester and mixtures thereof; and said oligomer is selected from the group consisting of oligopeptides, oligonucleotides, oligosaccharides, oligomer amino acid, oligoesters, oligoethers, oligosiloxanes, and oligomers of lactide oligomers and mixtures thereof.

In this paragraph Applicants disclose the process of the previous two paragraphs wherein said liquid comprises an organic solvent, preferably said organic solvent is selected from the group consisting of acetonitrile, ethyl acetate, acetone, benzaldehyde, benzyl benzoate, benzyl ether, benzonitrile, bromobenzene, chlorobenzene, dichlorobenzene cyclohexylpyrrolidone, chloroform, cyclohexane, cyclohexanone, dimethylacetamide, dimethylformamide, dimethylimidazolidinone, dimethylsulphoxide, N-dodecylpyrrolidone, formamide, isopropanol, methanol, ethanol, tetrahydrofuran, N-methylformamide, N-methyl-pyrrolidinone, N-octylpyrrolidone, quinoline, N-vinylpyrrolidone and mixtures thereof, more preferably said organic solvent is selected from the group consisting of acetonitrile, N-methyl-pyrrolidinone and mixtures thereof.

In this paragraph Applicants disclose the process of the previous three paragraphs wherein said three-dimensional van der Waals material comprises a metal, preferably said three-dimensional van der Waals material comprises: a metal chalcogenide, a metal oxide, a metal thio, seleno phosphate a metal silicon and/or a germanium telluride compound: preferably said metal chalcogenide comprises: a metal dichalcogenide having the formula MX₂, wherein M is Ti, V, Cr, Mn, Fe, Co, Ni, Cu, Zn, Zr, Nb, Mo, Tc, Ru, Rh, Pd, Cd, Hf, Ta, W, Re, Os, Ir, Pt, Ce, Pr, Nd, Pm, Sm, Eu, Gd, Tb, Dy, Ho, Er, Tm, Yb, or Lu, and X is S, Se, or Te; and/or a transition metal dichalcogenide having the formula MXY, wherein M is Ti, V, Cr, Mn, Fe, Co, Ni, Cu, Zn, Zr, Nb, Mo, Tc, Ru, Rh, Pd, Hf, Ta, W, Re, Os, Ir, or Pt, X is S, Se, or Te, and Y is S, Se, or Te; preferably said metal oxide is a non-van der Waals material comprising a metal oxide having the formula MₙXₘ, wherein M is Ti, V, Cr, Mn, Fe, Co, Ni, Cu, Zn, Zr, Nb, Mo, Tc, Ru, Rh, Pd, Cd, Hf, Ta, W, Re, Os, Ir, Pt, Ce, Pr, Nd, Pm, Sm, Eu, Gd, Tb, Dy, Ho, Er, Tm, Yb, or Lu, and X is O wherein the indice n is a number that is greater than zero to about 3 and the indice m is a number that is greater than zero to about 6; preferably said metal thio and seleno phosphate comprises a metal thio or selenophosphate having: the formula MPX₃ wherein X is S or Se and M is Cd, Zr, Mo, Ru, Rh, Co, Fe, Mg, Mn, Ni, Pd, V, Zn, Hg, Cr, Ca, Sr, Ir, Pt, Re, Ta, Hf, or Ba; the formula M_{1.3}P₂X₆, wherein X is S or Se and M is Al, In, Bi, Au, Cr, Sc, Ga, Y, La, Ce, Pr, Nd, Sm, Eu, Gd, Tb, Dy, Ho, Er, Tm, Yb, or Lu; the formula AMP₂X₆ wherein X is S or Se, A is a monovalent positively charged cation preferably A is Li, Na, K, Rb, Cs, Cu, Ag, or Au and M is Al, In, Bi, Au, Cr, Sc, Ga, Y, La, Ce, Pr, Nd, Sm, Eu, Gd, Tb, Dy, Ho, Er, Tm, Yb, or Lu; the formula MP₂X₆ wherein X is S or Se, and M is Sn, Pb, V or Mn; the formula A₂MP₂X₆ wherein X is S or Se, A is a monovalent positively charged cation, preferably A is Li, Na, K, Rb, Cs, Cu, Ag, Au and M is Cd, Zr, Mo, Ru, Rh, Co, Fe, Mg, Mn, Ni, Pd, V, Zn, Hg, Cr, Ca, Sr, Ir, Pt, Re, Ta, Hf, or Ba; preferably said metal silicon or germanium telluride compound comprises a metal silicon or germanium telluride compound having the formula MATe₃ wherein A is Si or Ge and M is a metal Cd, Zr, Mo, Ru, Rh, Co, Fe, Mg, Mn, Ni, Pd, V, Zn, Hg, Cr, Ca, Sr, Ir, Pt, Re, Ta, Hf, Ba, Al, In, Bi, Au, Cr, Sc, Ga, Y, La, Ce, Pr, Nd, Sm, Eu, Gd, Tb, Dy, Ho, Er, Tm, Yb, or Lu; and/or the formula M₃A₂Te₆ wherein A is Si or Ge and M is Cd, Zr, Mo, Ru, Rh, Co, Fe, Mg, Mn, Ni, Pd, V, Zn, Hg, Cr, Ca, Sr, Ir, Pt, Re, Ta, Hf, Ba, Al, In, Bi, Au, Cr, Sc, Ga, Y, La, Ce, Pr, Nd, Sm, Eu, Gd, Tb, Dy, Ho, Er, Tm, Yb, or Lu; preferably said three-dimensional material comprises a metal chalcogenide.

In this paragraph Applicants disclose the process of the previous four paragraphs wherein said two-dimensional material comprises 1 to 10 lamellae, preferably said two-dimensional material comprises 1 to 3 lamellae.

In this paragraph Applicants disclose the process of the previous five paragraphs wherein said two-dimensional material comprises: TiS₂, TiSe₂, TiTe₂, TiTe₂, VS₂, VSe₂, VTe₂, CrS₂, CrSe₂, CrTe₂, MnS₂, MnSe₂, MnTe₂, FeS₂, FeSe₂, FeTe₂, CoS₂, CoSe₂, CoTe₂, NiS₂, NiSe₂, NiTe₂, CuS₂, CuSe₂, CuTe₂, ZnS₂, ZnSe₂, ZnTe₂, ZrS₂, ZrSe₂, ZrTe₂, NbS₂, NbSe₂, NbTe₂, MoS₂, MoSe₂, MoTe₂, TcS₂, TcSe₂, TcTe₂, RuS₂, RuSe₂, RuTe₂, RhS₂, RhSe₂, RhTe₂, PdS₂, PdSe₂, PdTe₂, CdS₂, CdSe₂, CdTe₂, HfS₂, HfSe₂, HfTe₂, TaS₂, TaSe₂, TaTe₂, WS₂, WSe₂, WTe₂, ReS₂, ReSe₂, ReTe₂, OsS₂, OsSe₂, OsTe₂, IrS₂, IrSe₂, PtS₂, PtSe₂, PtTe₂, IrTe₂, HgS₂, HgSe₂, HgTe₂, CeS₂, CeSe₂ and/or CeTe₂; FeO, Fe₂O₃, Fe₃O₄, Al₂O₃, SiO₂, TiO₂, ZnO, CeO₂, VO₂, V₂O₅, Bi₂O₃, La₂O₃, Nd₂O₃, Y₂O₃, CuO, and/or Cu₂O; and/or LiInP₂Se₆, AgErP₂Se₆, CuInP₂S₆ and/or CuCrP₂S₆.

In this paragraph Applicants disclose the process of the previous six paragraphs wherein said colloidal dispersion comprises a crosslinker, preferably said crosslinker is selected from the group consisting of diacrylates, dimethacrylates, divinylbenzenes, diisocyanates, diallyl ethers, tetrafunctional epoxy monomers, triallyl cyanurate and/or triallyl isocyanurate.

In this paragraph Applicants disclose the process of the previous seven paragraphs wherein said first mixture, second mixture, third mixture and/or colloidal dispersion comprises a stabilizer, preferably said first mixture, second mixture, third mixture and colloidal dispersion comprise a stabilizer, preferably said stabilizer is selected from the group consisting of mequinol, butylated hydroxytoluene, tert-butylcatechol, hydroquinone and mixtures thereof.

In this paragraph Applicants disclose the process of the previous eight paragraphs wherein said first mixture, second mixture and/or third mixture comprises a liquid crystal, preferably said liquid crystal are thermotropic liquid crystals, discotic liquid crystals, lyotropic liquid crystals and/or metallotropic liquid crystals, more preferably said thermotropic liquid crystals, discotic liquid crystals, lyotropic liquid crystals and/or metallotropic liquid crystals are nematic liquid crystals, most preferably said thermotropic liquid crystals, discotic liquid crystals, lyotropic liquid crystals and/or metallotropic liquid crystals are chiral nematic liquid crystals.

In this paragraph Applicants disclose the process of the previous nine paragraphs wherein said first mixture, second mixture and/or third mixture comprises a chiral dopants, preferably said chiral dopant is a cholesteryl derivative, a binaphthyl derivative, a helicene, a chiral oxazoline derivative and/or chiral lactate.

### Process of Making a Polymer Matrix Composite Film and Articles Comprising Same

In this paragraph Applicants disclose a process of making a polymer matrix composite film comprising curing a colloidal dispersion that has been applied to a surface of an article, said colloidal dispersion being a colloidal dispersion made according to the process of one of the previous ten paragraphs of the section of this specification titled “Colloidal Dispersions and Processes Of Making and Using Same”, preferably said curing comprises monomer initiation or polymerization using photopolymerization, cationic polymerization, anionic polymerization, radical polymerization, suspension polymerization, emulsion polymerization, dispersion polymerization, and/or controlled living polymerization, preferably said controlled living polymerization comprises atom transfer radical polymerization and/or reversible addition-fragmentation chain transfer polymerization, preferably said colloidal dispersion is applied to said surface by drop casting, spin coating, dip coating, spray coating, doctor blading, vacuum filtering, Mayer rod coating, screen printing, inkjet printing, or Langmuir Blodgett depositing; or preparing a two-dimensional metasurface from said colloidal dispersion made according to the process of one of the previous ten paragraphs of the section of this specification titled “Colloidal Dispersions and Processes Of Making and Using Same”, by photolithographing, reactive ion etching, e-beam lithographing, shadow sphere template lithographing, sacrificial metal mask template lithographing and/or nanoimprinting said colloidal dispersion made according to the process of one of the previous ten paragraphs of the section of this specification titled “Colloidal Dispersions and Processes Of Making and Using Same”.

In this paragraph Applicants disclose the process of the previous paragraph, said process comprising delaminating said polymer matrix composite film from said surface of said article.

In this paragraph Applicants disclose the process of the previous two paragraphs wherein said article is a pellet, granule, powder, filament, sheet, film, fiber, rod, bar, tube, pipe, foam, block, billet, profile, extrusion, gel and/or coating.

In this paragraph Applicants disclose a process of making a polymer matrix composite comprising curing a colloidal dispersion made according to the process of the first ten paragraphs of this specification's section titled “Colloidal Dispersions and Processes Of Making and Using Same”, preferably said curing comprises monomer initiation or polymerization using photopolymerization, cationic polymerization, anionic polymerization, radical polymerization, suspension polymerization, emulsion polymerization, dispersion polymerization, and/or controlled living polymerization, preferably said controlled living polymerization comprises atom transfer radical polymerization and/or reversible addition-fragmentation chain transfer polymerization.

In this paragraph Applicants disclose a process of making an article comprising extruding, injection molding, blow molding, compression molding, rotational molding, thermoforming, calendaring, foaming, casting, and/or additive manufacturing including three-dimensional printing, fused deposition modeling, stereolithography, selective laser sintering, digital light processing, binder jetting, material jetting, and/or electron beam melting a polymer matrix composite made according the previous paragraph, preferably said article is: a construction material including composite piping, external panels, interior panels, body panels, foam boards, siding, rubbers, gaskets, adhesives, pressure sensitive adhesives, sealants, anaerobic sealants, paints, coatings, and/or combinations thereof; an automotive or aerospace material component including composite panels, tires, foam, panels, gaskets, appliques, pressure sensitive adhesives, protective top coats, hosing, bushings, mounts, manifolds, belts, connectors, ties, reinforced components, wing skins, empennage components, fairings, cabin panels, flooring, seat structures, storage bins, insulation blankets and/or appliques, heat shields, high-temperature components, electrostatic discharge components, fireproof components, hydraulic hoses, pneumatic tubing, fuel lines, and/or combinations thereof; or electronic material components including composite external casing, internal casing, cable insulation, resins for circuit boards, resin-based substrates, flexible printed circuit boards, insulation for electrical wires and/or cables, capacitors and insulation films, film capacitors, enclosures and/or housings, plastic cases, electronic packaging components, elastomeric connectors, polymer-based organic light-emitting diode displays, conductive polymers for electrostatic discharge, antistatic packaging materials, polymer overlays with conductive traces, rubber keypads, insulating films and/or tapes, masking, insulation and/or dielectric components, high-temperature and/or high-frequency components, polymer electrolytes, separator membranes, sealants, passive thermal management components, and/or combinations thereof.

### Colloidal Dispersion

In this paragraph, Applicants disclose a colloidal dispersion comprising: High purity starting source layered material is exfoliated in liquid monomer media. The exfoliation process is facilitated via mild bath sonication. The resulting exfoliated material (i.e., nanosheets or monolayer/near-monolayer two-dimensional material) is isolated via cascade centrifugation. The isolated nanosheets in liquid monomer yield a stable colloidal dispersion. The colloid is then processed into a thin film from solution via a selected method (e.g., drop cast, dip coat, spray coat, etc.) and the monomer is cured to form a polymer film. The resulting polymer film is considered a polymer matrix composite comprised of both polymer and the exfoliated nanosheets. The resulting polymer matrix composite thin film is considered the end technology form factor, but could also be further processed into an metasurface or incorporated as part of a selected device architecture.

In this paragraph Applicants disclose the beneficial properties of liquid crystals as a component for nanocomposites preparation. Liquid crystals are anisotropic molecules that spontaneously self-assemble resulting in different optical properties. There are different types of liquid crystals such as nematics which exhibit long-range one-dimensional order. Cholesterics on the other hand are made by adding a chiral molecule to a nematic liquid crystal resulting in a helical structure with either left or right-handed chirality. Liquid crystals can be manipulated by external stimuli such as electric field as well as temperature due to the dielectric properties and phase transition temperature, respectively. Most liquid crystals are organic molecules with a rigid aromatic core and a flexible alkyl chain. These can also be modified to be monomers (acrylates, norbornenes) from which liquid crystalline polymers can be made. These are suitable for incorporating nanomaterials towards the development of nanocomposites with varying optical properties.

In this paragraph, Applicants disclose a facile ‘one-pot’ approach, utilizing anisotropic liquid crystals and monomers to exfoliate 2D nanomaterials. The liquid crystal molecules are compatible with 2D materials and the exfoliation methodology. Nanocomposites were prepared using a mixture comprising a nematic liquid crystal with chiral dopant and methyl methacrylate monomer. The combination of the nematic liquid crystal with the chiral dopant forms cholesteric mixture which can act as a template to assemble 2D nanomaterials. Methyl methacrylate monomer was used as an exfoliation solvent and as a readily polymerizable monomer system. Bulk layered source powders were added to the liquid crystal/monomer medium and exfoliated. In another formulation, a liquid crystalline monomer is used as the nematic liquid crystal which enables the direct preparation of 2D nanomaterial composites in liquid crystalline polymers. The resulting nanocomposites from these approaches can be easily processed into thin films having tunable or fixed optical properties.

### Test Methods

The absorption optical spectra of exfoliated two-dimensional materials were measured using a Cary 5000 UV-Vis-NIR spectrophotometer. Quartz cuvettes having a pathlength ranging from 1-10 mm were used depending on the concentration of the colloidal dispersion involving solution UV-Vis-NIR spectrophotometry.

Transmission electron microscopy (TEM) images were collected using a Talos 200 KV transmission electron microscope. Samples in monomer were drop-cast on a TEM grid (i.e., ultrathin carbon on lacy supported by a 400-mesch copper grid). Drop-cast samples were squeegeed on the grid and excess sample was removed with a Kim wipe.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: We prepared the transition metal chalcogenides and related bulk three-dimensional materials using the following general procedure. The metal components of the compounds, generalized with the formula MX₂, were either sourced as 1) metal foil, generally <100 μm in thickness or 2) powders. If the latter case, we first reduced the powders at 200-300° C. under flowing H₂ to remove any oxide contamination. We combined the metal with the chalcogen material (e.g. S, Se, Te) in the molar ratio M:X of 1:2.05. The excess chalcogen was present to ensure full reaction of the metal. We also added I₂ (quantity adjusted to ensure 1-2 atmospheric pressure at reaction temperature) to act as a as a mineralizer/vapor transport agent to ensure reaction completion and ensure increased quality of the final crystalline material. These precursor materials were sealed, under vacuum, in a quartz ampoule. We reacted the ampoule at temperatures ranging from 700° C. to 1200° C. (depending on the targeted composition); heating was applied as a rate of 30° C. per hour to the final reaction temperature, held at that temperature for periods ranging from 100-200 hours, and cooled to room temperature at the same rate as heating. After cooling, the ampoules were sectioned and the I₂ was let to evaporate in a fume hood until it was completely dispersed. The final crystals were then removed from the quartz ampoule and used for further processing and characterization as described below.

Example 2: Previously prepared MoS₂ (˜20 mg), as described in Example 1, was added to a 20 mL glass vial followed by methyl methacrylate (˜5 mL). The vial was capped and lowered into a sonication bath, pre-warmed to 32° C. The vial was lowered into the bath and sonicated for ˜1.5 hours. After the allotted time the vial was removed from the bath and non-exfoliated material was allowed to settle. The remaining dispersion was transferred to and centrifuge tube via pipette. The suspension was spun at ˜6,000 RPM for 20 minutes. After centrifugation, the supernatant containing colloidal MoS₂ nanoflakes was carefully transferred to another vial for additional processing.

Example 3: The same procedure as example 1 was followed except the methyl methacrylate was replaced with n-butyl methacrylate.

Example 4: The same procedure as example 1 was followed except the methyl methacrylate was replaced with stearyl methacrylate.

Example 5: The same procedure as example 1 was followed except the methyl methacrylate was replaced with lauryl methacrylate.

Example 6: The same procedure as example 1 was followed except the methyl methacrylate was replaced with 1,4-butane diol dimethacrylate.

Example 7: The same procedure as example 1 was followed except the methyl methacrylate was replaced with trimethylolpropane triacrylate.

Example 8: The same procedure as example 1 was followed except the methyl methacrylate was replaced with a 50/50 mix of styrene/acetonitrile.

Example 9: The same procedure as example 1 was followed except the methyl methacrylate was replaced with a 95/5 mix of styrene/acetonitrile.

Example 10: The same procedure as example 1 was followed except the methyl methacrylate was replaced with 4-amino styrene.

Example 11: The same procedure as example 1 was followed except the methyl methacrylate was replaced with triallyl isocyanurate.

Example 12: The same procedure as example 1 was followed except MoS₂ was replaced with WS₂.

Example 13: The same procedure as example 1 was followed except MoS₂ was replaced with WS₂ and the methyl methacrylate was replaced with n-butyl methacrylate.

Example 14: The same procedure as example 1 was followed except MoS₂ was replaced with WS₂ and the methyl methacrylate was replaced with steryl methacrylate.

Example 15: The same procedure as example 1 was followed except MoS₂ was replaced with WS₂ and the methyl methacrylate was replaced with lauryl methacrylate.

Example 16: The same procedure as example 1 was followed except for the following modifications: MoS₂ was replaced with Fe₂O₃ (hematite) and bath sonication carried out for 3.5 hours.

Example 17: The same procedure as example 15 was followed except methyl methacrylate was replaced with trimethylolpropane triacrylate.

Example 18: The same procedure as example 1 was followed except for the following modifications: MoS₂ was replaced with NbS₂. After the addition of methyl methacrylate, the vial was capped with a rubber septa and sealed with tape. The methyl methacrylate was purged by bubbling in nitrogen for several minutes through a needle and venting through an additional needle. The needle was then raised out of the solution and the vent needle was removed while continuing the flow of nitrogen. The vial was kept under nitrogen for the remainder of the sonication. Once purged the vial was lowered into the sonication bath and sonicated for 5 hours instead of 1.5 hours.

Example 19: The same procedure as example 1 except a cholesteric liquid crystal mixture was added comprised of nematic liquid crystal 5CB (4-Cyano-4′-pentylbiphenyl and chiral dopant R/S1011 ((R/S)-1-Phenyl-1,2-ethanediyl Bis[4-(trans-4-pentylcyclohexyl)benzoate]. The sonication bath temperature was set to 45° C. to keep the liquid crystal in the isotropic state. In another formulation, the nematic liquid crystal 5CB is replaced with a polymerizable nematic liquid crystal monomer RM82 (1,4-Bis[4-(6-acryloyloxyhexyloxy)benzoyloxy]-2-methylbenzene) during the preparation of the cholesteric mixture. After exfoliation, excess methyl methacrylate is removed on a hot plate (set to 120° C.) and the resulting mixture is ready for polymerization.

Example 20: A known weight of flakes/monomer solution (˜396 mg) was added to a vial and photoinitiator (1%, 2, 2-dimethoxy-1, 2-diphenylethanone) added (e.g. 4 mg). The mixture was sonicated (at room temperature) and vortexed until the initiator was well dispersed in the monomer mixture. The mixture was cured by drop-casting on glass slides or curing directly in a scintillation vial by illuminating under a 365 nm LED light source. Drop-casted samples were polymerized at shorter times (<30 min) compared to samples in a vial (6-8 hours). The removal of unreacted monomer was done by leaving samples in the hood for a few days (3 days, in the case of samples in the vial) and then in a vacuum oven (temperature <50 C) for at least 3 hour). The cured polymer matrix composite samples in the vial were retrieved by gently breaking the vial with a hammer.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and process, and illustrative examples shown and described. Accordingly, departures may be made from such details without departing from the scope of the general inventive concept.

What is claimed is:

1. A process for producing a colloidal dispersion, said process comprising:
a) bath sonicating a first mixture comprising a three-dimensional van der Waals material, a liquid having a viscosity of from about 0.1 cP to about 1000 cP, said liquid comprising a monomer, dimer, trimer and/or oligomer, and an optional stabilizer to form a second mixture comprising said three-dimensional van der Waals material, a two-dimensional material and said liquid; and
b) centrifuging said second mixture to separate said second mixture into a third mixture comprising said three-dimensional van der Waals material, an optional stabilizer, two-dimensional material, and said liquid; and a colloidal dispersion comprising said two-dimensional material, an optional stabilizer, and said liquid.

2. The process of claim 1 wherein said liquid of said first mixture is from 0.1 cP to about 100 cP.

3. The process of claim 1 wherein:
a) said monomer is selected from the group consisting of olefin, vinyl, diene, styrenic, acrylic, condensation, amide, epoxy, and silicone monomers and mixtures thereof;
b) said dimer is selected from the group consisting of disulfide, diol, disiloxane, diamine, diacid, diisocyanate, and diester dimers and mixtures thereof;
c) said trimer is selected from the group consisting of trisulfide, triol, trisiloxane, triamine, triacid, triisocyanate, and triester and mixtures thereof; and
d) said oligomer is selected from the group consisting of oligopeptides, oligonucleotides, oligosaccharides, oligomer amino acid, oligoesters, oligoethers, oligosiloxanes, and oligomers of lactide oligomers and mixtures thereof.

4. The process of claim 1 wherein said liquid comprises an organic solvent.

5. The process of claim 4 wherein said organic solvent is selected from the group consisting of acetonitrile, ethyl acetate, acetone, benzaldehyde, benzyl benzoate, benzyl ether, benzonitrile, bromobenzene, chlorobenzene, dichlorobenzene cyclohexylpyrrolidone, chloroform, cyclohexane, cyclohexanone, dimethylacetamide, dimethylformamide, dimethylimidazolidinone, dimethylsulphoxide, N-dodecylpyrrolidone, formamide, isopropanol, methanol, ethanol, tetrahydrofuran, N-methylformamide, N-methyl-pyrrolidinone, N-octylpyrrolidone, quinoline, N-vinylpyrrolidone and mixtures thereof.

6. The process of claim 5 wherein said organic solvent is selected from the group consisting of acetonitrile, N-methyl-pyrrolidinone and mixtures thereof.

7. The process of claim 1 wherein said three-dimensional van der Waals material comprises a metal.

8. The process of claim 7 wherein said three-dimensional van der Waals material comprises: a metal chalcogenide, a metal oxide, a metal thio, seleno phosphate a metal silicon and/or a germanium telluride compound.

9. The process of claim 8 wherein
a) said metal chalcogenide comprises: a metal dichalcogenide having the formula MX₂, wherein M is Ti, V, Cr, Mn, Fe, Co, Ni, Cu, Zn, Zr, Nb, Mo, Tc, Ru, Rh, Pd, Cd, Hf, Ta, W, Re, Os, Ir, Pt, Ce, Pr, Nd, Pm, Sm, Eu, Gd, Tb, Dy, Ho, Er, Tm, Yb, or Lu, and X is S, Se, or Te; and/or a transition metal dichalcogenide having the formula MXY, wherein M is Ti, V, Cr, Mn, Fe, Co, Ni, Cu, Zn, Zr, Nb, Mo, Tc, Ru, Rh, Pd, Hf, Ta, W, Re, Os, Ir, or Pt, X is S, Se, or Te, and Y is S, Se, or Te;
b) said metal oxide is a non-van der Waals material comprising a metal oxide having the formula MₙXₘ, wherein M is Ti, V, Cr, Mn, Fe, Co, Ni, Cu, Zn, Zr, Nb, Mo, Tc, Ru, Rh, Pd, Cd, Hf, Ta, W, Re, Os, Ir, Pt, Ce, Pr, Nd, Pm, Sm, Eu, Gd, Tb, Dy, Ho, Er, Tm, Yb, or Lu, and X is O wherein the indice n is a number that is greater than zero to about 3 and the indice m is a number that is greater than zero to about 6;
c) said metal thio and seleno phosphate comprises a metal thio or selenophosphate having:
(i) the formula MPX₃ wherein X is S or Se and M is Cd, Zr, Mo, Ru, Rh, Co, Fe, Mg, Mn, Ni, Pd, V, Zn, Hg, Cr, Ca, Sr, Ir, Pt, Re, Ta, Hf, or Ba;
(ii) the formula M_{1.3}P₂X₆, wherein X is S or Se and M is Al, In, Bi, Au, Cr, Sc, Ga, Y, La, Ce, Pr, Nd, Sm, Eu, Gd, Tb, Dy, Ho, Er, Tm, Yb, or Lu;
(iii) the formula AMP₂X₆ wherein X is S or Se, A is a monovalent positively charged cation and M is Al, In, Bi, Au, Cr, Sc, Ga, Y, La, Ce, Pr, Nd, Sm, Eu, Gd, Tb, Dy, Ho, Er, Tm, Yb, or Lu;
(iv) the formula MP₂X₆ wherein X is S or Se, and M is Sn, Pb, V or Mn; and
(v) the formula A₂MP₂X₆ wherein X is S or Se, A is a monovalent positively charged cation; and
d) said metal silicon or germanium telluride compound comprises a metal silicon or germanium telluride compound having the formula MATe₃ wherein A is Si or Ge and M is a metal Cd, Zr, Mo, Ru, Rh, Co, Fe, Mg, Mn, Ni, Pd, V, Zn, Hg, Cr, Ca, Sr, Ir, Pt, Re, Ta, Hf, Ba, Al, In, Bi, Au, Cr, Sc, Ga, Y, La, Ce, Pr, Nd, Sm, Eu, Gd, Tb, Dy, Ho, Er, Tm, Yb, or Lu; and/or the formula M₃A₂Te₆ wherein A is Si or Ge and M is Cd, Zr, Mo, Ru, Rh, Co, Fe, Mg, Mn, Ni, Pd, V, Zn, Hg, Cr, Ca, Sr, Ir, Pt, Re, Ta, Hf, Ba, Al, In, Bi, Au, Cr, Sc, Ga, Y, La, Ce, Pr, Nd, Sm, Eu, Gd, Tb, Dy, Ho, Er, Tm, Yb, or Lu.

10. The process of claim 8 wherein said three-dimensional material comprises a metal chalcogenide.

11. The process of claim 1 wherein said two-dimensional material comprises 1 to 10 lamellae, preferably said two-dimensional material comprises 1 to 3 lamellae.

12. The process of claim 1 wherein said two-dimensional material comprises 1 to 3 lamellae

13. The process of claim 1 wherein said two-dimensional material comprises:
a) TiS₂, TiSe₂, TiTe₂, TiTe₂, VS₂, VSe₂, VTe₂, CrS₂, CrSe₂, CrTe₂, MnS₂, MnSe₂, MnTe₂, FeS₂, FeSe₂, FeTe₂, CoS₂, CoSe₂, CoTe₂, NiS₂, NiSe₂, NiTe₂, CuS₂, CuSe₂, CuTe₂, ZnS₂, ZnSe₂, ZnTe₂, ZrS₂, ZrSe₂, ZrTe₂, NbS₂, NbSe₂, NbTe₂, MoS₂, MoSe₂, MoTe₂, TcS₂, TcSe₂, TcTe₂, RuS₂, RuSe₂, RuTe₂, RhS₂, RhSe₂, RhTe₂, PdS₂, PdSe₂, PdTe₂, CdS₂, CdSe₂, CdTe₂, HfS₂, HfSe₂, HfTe₂, TaS₂, TaSe₂, TaTe₂, WS₂, WSe₂, WTe₂, ReS₂, ReSe₂, ReTe₂, OsS₂, OsSe₂, OsTe₂, IrS₂, IrSe₂, PtS₂, PtSe₂, PtTe₂, IrTe₂, HgS₂, HgSe₂, HgTe₂, CeS₂, CeSe₂ and/or CeTe₂;
b) FeO, Fe₂O₃, Fe₃O₄, Al₂O₃, SiO₂, TiO₂, ZnO, CeO₂, VO₂, V₂O₅, Bi₂O₃, La₂O₃, Nd₂O₃, Y₂O₃, CuO, and/or Cu₂O; and/or
c) LiInP₂Se₆, AgErP₂Se₆, CuInP₂S₆ and/or CuCrP₂S₆.

14. The process of claim 1 wherein said colloidal dispersion comprises a crosslinker.

15. The process of claim 4 wherein said crosslinker is selected from the group consisting of diacrylates, dimethacrylates, divinylbenzenes, diisocyanates, diallyl ethers, tetrafunctional epoxy monomers, triallyl cyanurate and/or triallyl isocyanurate.

16. The process of claim 1 wherein said first mixture, second mixture, third mixture and/or colloidal dispersion comprises a stabilizer.

17. The process of claim 1 wherein said first mixture, second mixture, third mixture and colloidal dispersion comprise a stabilizer.

18. The process of claim 16 wherein said stabilizer is selected from the group consisting of mequinol, butylated hydroxytoluene, tert-butylcatechol, hydroquinone and mixtures thereof.

19. The process of claim 1 wherein said first mixture, second mixture and/or third mixture comprises a liquid crystal.

20. The process of claim 19 wherein said liquid crystal is a thermotropic liquid crystal, discotic liquid crystal, lyotropic liquid crystal and/or metallotropic liquid crystal.

21. The process of claim 20 wherein said thermotropic liquid crystals, discotic liquid crystals, lyotropic liquid crystals and/or metallotropic liquid crystals are nematic liquid crystals.

22. The process of claim 21 wherein said thermotropic liquid crystals, discotic liquid crystals, lyotropic liquid crystals and/or metallotropic liquid crystals are chiral nematic liquid crystals.

23. The process of claim 1 wherein said first mixture, second mixture and/or third mixture comprises a chiral dopant.

24. The process of claim 1 wherein said chiral dopant is a cholesteryl derivative, a binaphthyl derivative, a helicene, a chiral oxazoline derivative and/or chiral lactate.

25. A process of making:
a) a polymer matrix composite film comprising curing a colloidal dispersion that has been applied to a surface of an article, said colloidal dispersion being a colloidal dispersion made according to the process of claim 1; or
b) preparing a two-dimensional metasurface from said colloidal dispersion made according to the process of claim 1, by photolithographing, reactive ion etching, e-beam lithographing, shadow sphere template lithographing, sacrificial metal mask template lithographing and/or nanoimprinting said colloidal dispersion made according to the process of claim 1.

26. The process of claim 25 wherein said curing comprises monomer initiation or polymerization using photopolymerization, cationic polymerization, anionic polymerization, radical polymerization, suspension polymerization, emulsion polymerization, dispersion polymerization, and/or controlled living polymerization, preferably said controlled living polymerization comprises atom transfer radical polymerization and/or reversible addition-fragmentation chain transfer polymerization, preferably said colloidal dispersion is applied to said surface by drop casting, spin coating, dip coating, spray coating, doctor blading, vacuum filtering, Mayer rod coating, screen printing, inkjet printing, or Langmuir Blodgett depositing

27. The process of claim 25 comprising delaminating said polymer matrix composite film from said surface of said article.

28. The process of claim 25 wherein said article is a pellet, granule, powder, filament, sheet, film, fiber, rod, bar, tube, pipe, foam, block, billet, profile, extrusion, gel, and/or coating.

29. A process of making a polymer matrix composite comprising curing a colloidal dispersion made according to the process of claim 1.

30. The process of making a polymer matrix composite according to claim 29, wherein said curing comprises monomer initiation or polymerization using photopolymerization, cationic polymerization, anionic polymerization, radical polymerization, suspension polymerization, emulsion polymerization, dispersion polymerization, and/or controlled living polymerization.

31. The process of making a polymer matrix composite according to claim 30 wherein said controlled living polymerization comprises atom transfer radical polymerization and/or reversible addition-fragmentation chain transfer polymerization.

32. A process of making an article comprising extruding, injection molding, blow molding, compression molding, rotational molding, thermoforming, calendaring, foaming, casting, and/or additive manufacturing including three-dimensional printing, fused deposition modeling, stereolithography, selective laser sintering, digital light processing, binder jetting, material jetting, and/or electron beam melting a polymer matrix composite made according claim 29.
